(19) United States
(12) Patent Application Publication
(10) Pub. No.: US 2012/0046115 A1
(43) Pub. Date: Feb. 23, 2012

(54) Bolt Thread Damage Prevention Assembly

(76) Inventor: Michael Chernek, Cleveland, OH (US)

(21) Appl. No.: 12/860,399

(22) Filed: Aug. 20, 2010

(51) Int. Cl. B23G 11/00; B21K 1/56

(52) U.S. Cl. 470/47; 470/57

(57) ABSTRACT

A bolt thread damage prevention assembly for minimizing thread damage to produced and packaged bolts includes a bolt production assembly, threaded bolts produced by the bolt production assembly, and a bolt tray for receiving the threaded bolts. A drop pan holds the bolt tray. Oil is positioned in the drop pan and a plurality of air jets create turbulence in the oil in the drop pan. The bolt tray is perforated for permitting the oil to enter the bolt tray in a turbulent state. A distribution conveyor belt is positioned to drop the threaded bolts into the bolt tray while the bolt tray is positioned in the drop pan while the oil is in the turbulent state. A collection pan is provided for collecting threaded bolts from the bolt tray. A bolt tray transport assembly moves the bolt tray from the drop pan to the collection pan.

### BACKGROUND OF THE DISCLOSURE

### Field of the Disclosure

The disclosure relates to bolt producers and more particularly pertains to a new bolt producer for minimizing thread damage to produced and packaged bolts.

### SUMMARY OF THE DISCLOSURE

An embodiment of the disclosure meets the needs presented above by generally comprising a bolt production assembly, threaded bolts produced by the bolt production assembly, and a bolt tray for receiving the threaded bolts. A drop pan holds the bolt tray while the bolt tray receives the threaded bolts. Oil is positioned in the drop pan and a plurality of air jets creates turbulence in the oil in the drop pan. The bolt tray is perforated for permitting the oil to enter the bolt tray in a turbulent state. A distribution conveyor belt is positioned to drop the threaded bolts into the bolt tray while the bolt tray is positioned in the drop pan while the oil is in the turbulent state. A collection pan is provided for collecting threaded bolts from the bolt tray. A bolt tray transport assembly moves the bolt tray from the drop pan to the collection pan.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front top side perspective view of a bolt thread damage prevention assembly according to an embodiment of the disclosure.

FIG. 2 is a top view of an embodiment of the disclosure.

FIG. 3 is a side view of an embodiment of the disclosure.

FIG. 4 is a front view of an embodiment of the disclosure.

FIG. 5 is a cross-sectional view of an embodiment of the disclosure taken along line 5-5 of FIG. 2.

FIG. 6 is a front top side view of an embodiment of the disclosure.

FIG. 7 is a front view of a computer control system of an embodiment of the disclosure.

### DESCRIPTION OF THE PREFERRED EMBODIMENT

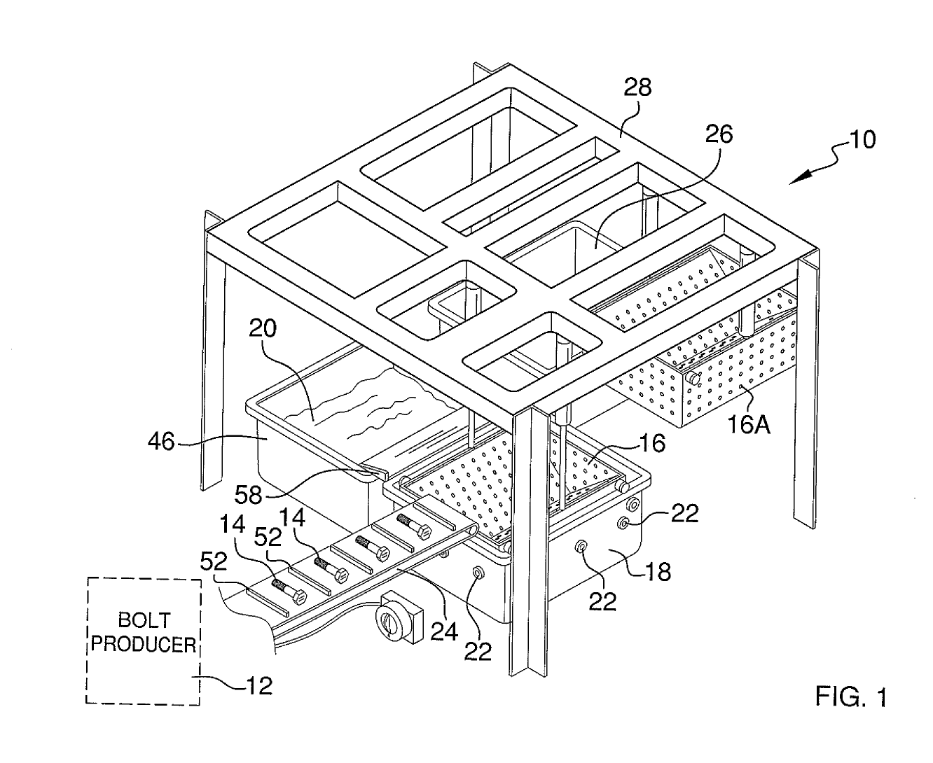

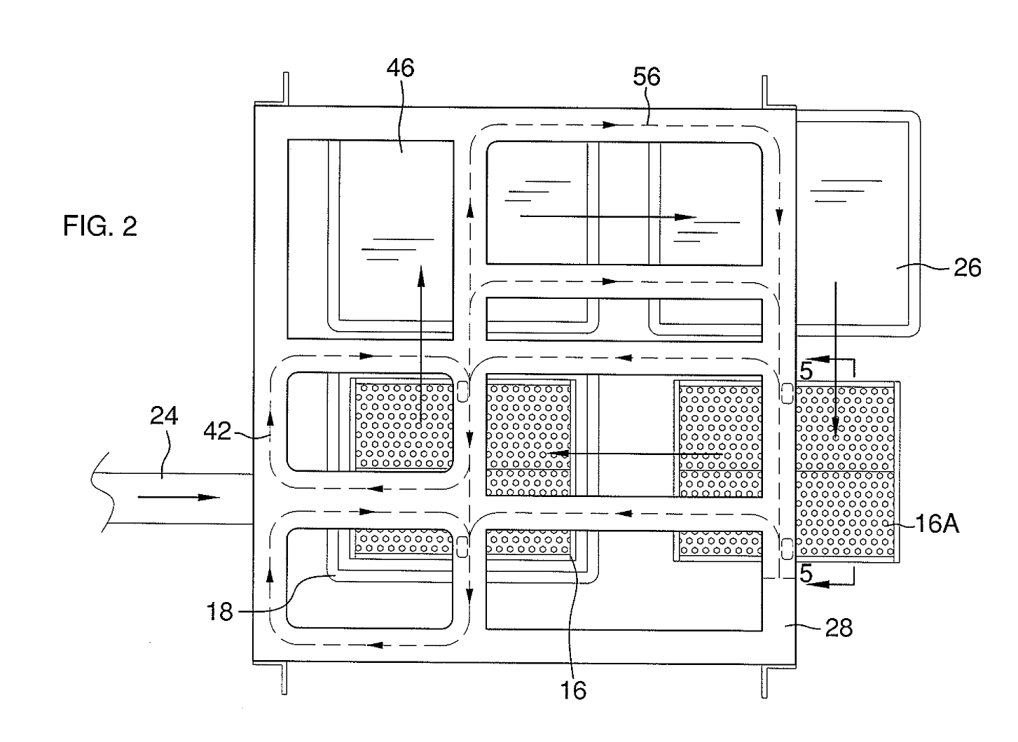

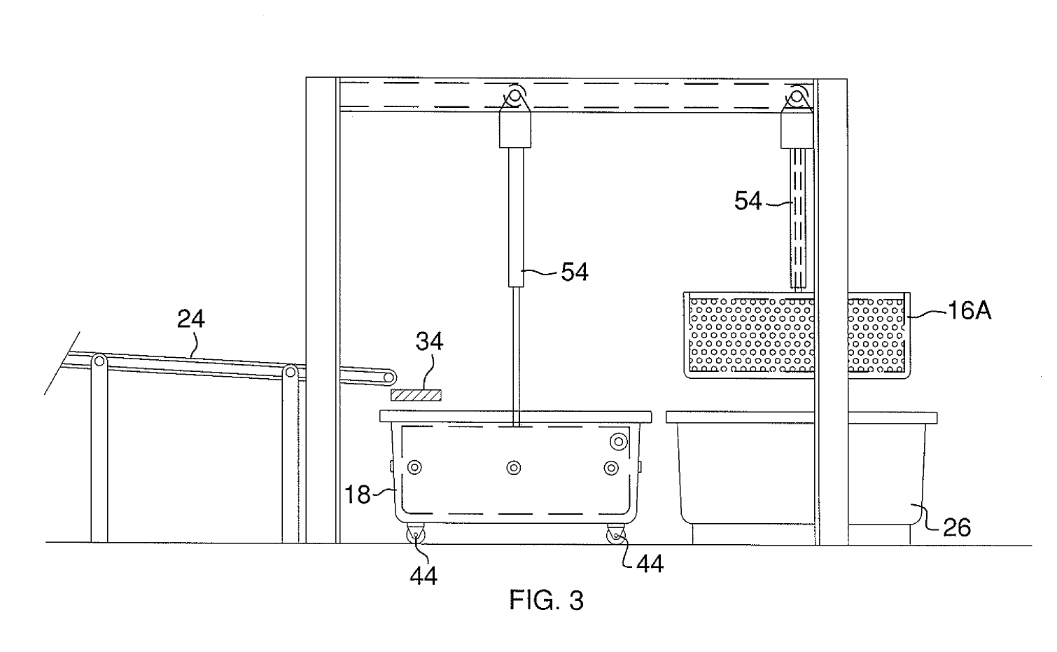

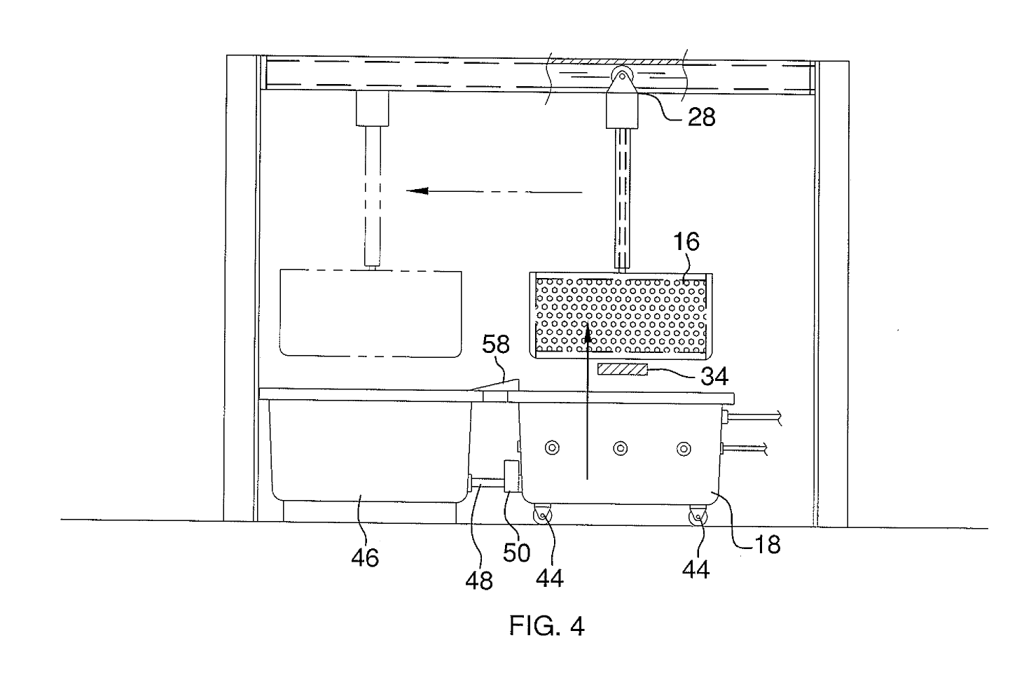

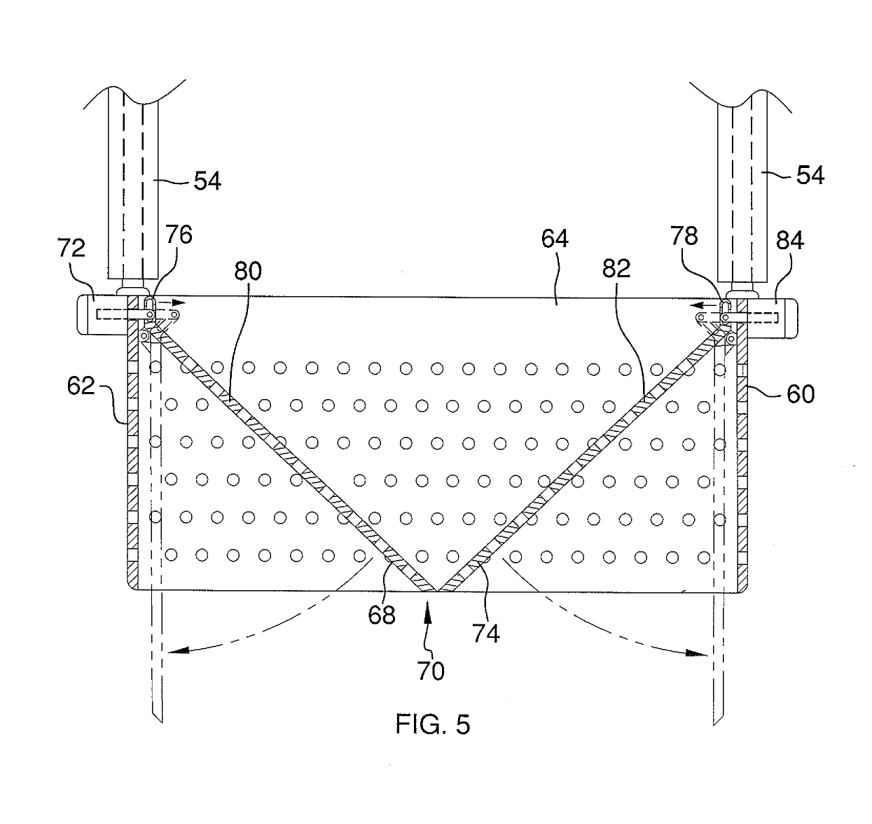

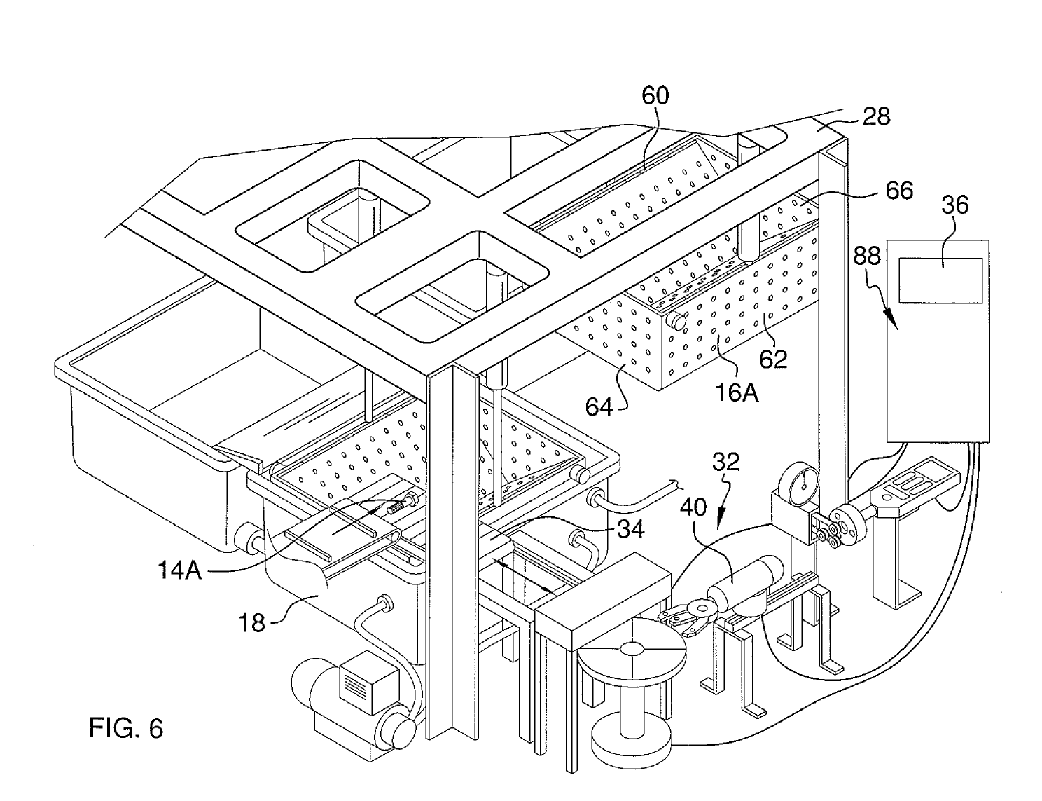

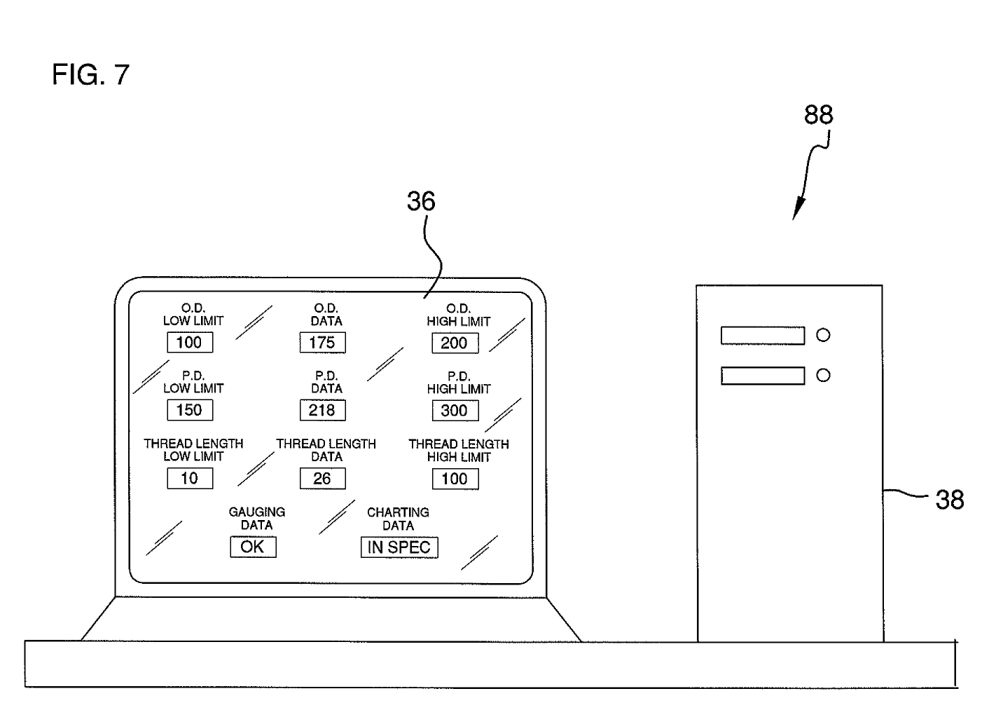

With reference now to the drawings, and in particular to FIGS. 1 through 7 thereof, a new bolt producer embodying the principles and concepts of an embodiment of the disclosure and generally designated by the reference numeral 10 will be described.

As best illustrated in FIGS. 1 through 7, the bolt thread damage prevention assembly 10 generally comprises a bolt production assembly 12, threaded bolts 14 produced by the bolt production assembly 12, and a bolt tray 16 for receiving the threaded bolts 14. A drop pan 18 is provided for holding the bolt tray 16 while the bolt tray 16 receives the threaded bolts 14. Oil 20 is positioned in the drop pan 18. A plurality of air jets 22 are coupled to and arranged around the drop pan 18 for creating turbulence in the oil 20 in the drop pan 18. The bolt tray 16 is perforated for permitting the oil 20 to enter the bolt tray 16 in a turbulent state. A distribution conveyor belt 24 is positioned to transport the threaded bolts 14 from the bolt production assembly 12 and drop the threaded bolts 14 into the bolt tray 16 while the bolt tray 16 is positioned in the drop pan 18. Thus, the threaded bolts 14 are dropped into the oil 20 while the oil 20 is in the turbulent state to reduce damage to the threads of the threaded bolts 14. A plurality of spaced vanes 52 is positioned on the distribution conveyor belt 24 for facilitating spacing of the threaded bolts 14 while on the distribution conveyor belt 24.

A collection pan 26 collects the threaded bolts 14 from the bolt tray 16. A bolt tray transport assembly 28 is provided to move the bolt tray 16 from the drop pan 18 to the collection pan 26. A second bolt tray 16A may also be operationally coupled to the bolt tray transport assembly 28 to facilitate collection and packaging of the threaded bolts 14 with greater efficiency.

A bolt thread testing assembly 32 is provided to insure quality control for the threaded bolts 14. A collection conveyor belt 34 is positioned adjacent to the distribution conveyor belt 24 for periodically extending and collecting a sample threaded bolt 14A and transporting the sample threaded bolt 14A to the bolt thread testing assembly 32. A computer management system 88 utilizing a computer 36 and monitor 38 is operationally coupled to the bolt thread testing assembly 32 and the collection conveyor belt 34. The bolt thread testing assembly 32 utilizes an optical inspection mechanism 40 for inspecting each sample threaded bolt 14A for defective threading.

The bolt tray transport assembly 28 has a bolt collection track portion 42 for moving the bolt tray 16 relative to the distribution conveyor belt 24 to facilitate even distribution of threaded bolts 14 in the bolt tray 16. Casters 44 are positioned on the drop pan 18 such that the drop pan 18 moves with the bolt tray 16 when the bolt tray 16 is moved on the bolt collection track portion 42.

A drip pan 46 collects residual oil dripping from the threaded bolts 14 when the bolt tray 16 is removed from the drop pan 18. An oil collection tube 48 extends between the drip pan 46 and the drop pan 18 such that oil collected in the drip pan 46 circulates back into the drop pan 18. An oil pump 50 is operationally coupled to the oil collection tube 48 for pumping collected oil from the drip pan 46 to the drop pan 18.

The bolt tray transport assembly 28 includes an extendable connection 54 to the bolt tray 16 for selectively elevating the bolt tray 16 out of the drop pan 18. The bolt tray transport assembly 28 further includes a bolt distribution track portion 56 for moving the bolt tray 16 from the drop pan 18 to above the drip pan 46 to above the collection pan 26. A drip tray 58 extends between the drop pan 18 and the drip pan 46. The drip tray 58 is sloped to divert oil falling from the bolt tray 16 into the drip pan 46.

The bolt tray 16 and the second bolt tray 16A have similar structure including a pair of side walls 60,62 and a pair of end walls 64,66 extending between the side walls 60,62. A door panel 68 is hingedly coupled to one of the side walls 60 to form a bottom 70 of the bolt tray 16 for supporting threaded bolts 14 collected in the bolt tray 16. A door actuator 72 is coupled to the door panel 68 for selectively pivoting the door panel 68 to release the threaded bolts 14 collected in the bolt tray 16.

In an embodiment of the invention, a pair of door panels 68,74 is provided. Each door panel 68,74 has a top portion 76,78 and a main portion 80,82 extending from the respective top portion 76,78 at an obtuse angle. The top portion 76,78 of each door panel 68,74 is hingedly coupled to an associated one of the side walls 60,62. Door actuators 72,84 are coupled to the top portions 76,78 of the door panels 68,74 for selectively pivoting the door panels 68,74 apart to release the threaded bolts 14 collected in the bolt tray 16.

In use, threaded bolts 14 are produced and transported to the bolt tray 16 by distribution conveyor belt 24. Sample threaded bolts 14A are intercepted for testing for quality assurance. The threaded bolts 14 are dropped into the bolt tray 16 while the bolt tray 16 is positioned in the drop pan 18 so that oil 20 injected with air by air jets 22 partially cushions the falling threaded bolts 14 to prevent damage to the threaded bolts 14. The bolt tray transport assembly 28 elevates the bolt tray 16 out of the drop pan 18 and moves the bolt tray 16 over the drip pan 46. Oil 20 is circulated back into the drop pan 18 by the oil pump 50. The bolt tray 16 is then moved over the collection pan 26 and the door panels 68,74 are pivoted to release the threaded bolts 14 into the collection pan 26. The bolt tray 16 is then circulated back to the drop pan 18 and the process continues from the beginning. A second drop tray 16A or more may be incorporated to increase efficiency in filling collection pans 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A bolt thread damage prevention assembly comprising:
a bolt production assembly;
threaded bolts produced by said bolt production assembly;
a bolt tray for receiving said threaded bolts;
a drop pan for holding said bolt tray while said bolt tray receives said threaded bolts;
oil positioned in said drop pan;
a plurality of air jets coupled to said drop pan for creating turbulence in said oil in said drop pan;
wherein said bolt tray is perforated for permitting said oil to enter said bolt tray in a turbulent state;
a distribution conveyor belt positioned to transport said threaded bolts from said bolt production assembly and drop said threaded bolts into said bolt tray while said bolt tray is positioned in said drop pan whereby said threaded bolts are dropped into said oil while said oil is in said turbulent state;
a collection pan for collecting threaded bolts from said bolt tray; and
a bolt tray transport assembly operationally for moving” said bolt tray from said drop pan to said collection pan.

2. The bolt thread damage prevention assembly of claim 1, further including a second bolt tray operationally coupled to said bolt tray transport assembly to facilitate collection and packaging of said threaded bolts.

3. The bolt thread damage prevention assembly of claim 1, further comprising:
a bolt thread testing assembly; and
a collection conveyor belt positioned adjacent to said support structure for periodically collecting a sample threaded bolt and transporting said sample threaded bolt to said bolt thread testing assembly.

4. The bolt thread damage prevention assembly of claim 1, further comprising:
said bolt tray transport assembly having a bolt collection track portion for moving said bolt tray relative to said distribution conveyor belt to facilitate even distribution of threaded bolts in said bolt tray.

5. The bolt thread damage prevention assembly of claim 4, further comprising:
casters positioned on said drop pan such that said drop pan moves with said bolt tray when said bolt tray is moved on said bolt collection track portion.

6. The bolt thread damage prevention assembly of claim 1, further including a drip pan for collecting residual oil dripping from said threaded bolts when said bolt tray is removed from said drop pan.

7. The bolt thread damage prevention assembly of claim 6, further including an oil collection tube extending between said drip pan and said drop pan such that oil collected in said drip pan circulates back into said drop pan.

8. The bolt thread damage prevention assembly of claim 7, further including an oil pump operationally coupled to said oil collection tube for pumping collected oil from said drip pan to said drop pan.

9. The bolt thread damage prevention assembly of claim 1, wherein said bolt tray further comprises:
a pair of side walls;
a pair of end walls extending between said side walls;
a door panel hingedly coupled to one of said side walls to form a bottom of said bolt tray for supporting threaded bolts collected in said bolt tray; and
a door actuator coupled to said door panel for selectively pivoting said door panel to release said threaded bolts collected in said bolt tray.

10. The bolt thread damage prevention assembly of claim 3, further comprising:
a computer management system operationally coupled to said bolt thread testing assembly and said collection conveyor belt; and
an optical inspection mechanism for inspecting each said sample threaded bolt for defective threading.

11. The bolt thread damage prevention assembly of claim 1, further including a plurality of spaced vanes positioned on said distribution conveyor belt for facilitating spacing of said threaded bolts while on said distribution conveyor belt.

12. The bolt thread damage prevention assembly of claim 6, wherein said bolt tray transport assembly transports includes an extendable connection to said bolt tray for selectively elevating said bolt tray out of said drop pan.

13. The bolt thread damage prevention assembly of claim 12, wherein said bolt tray transport assembly further includes a bolt distribution track portion for moving said bolt tray from said drop pan to above said drip pan to above said collection pan.

14. The bolt thread damage prevention assembly of claim 6, further including a drip tray extending between said drop pan and said drip pan, said drip tray being sloped to divert oil falling from said bolt tray into said drip pan.

15. The bolt thread damage prevention assembly of claim 1, wherein said bolt tray further comprises:
a pair of side walls;
a pair of end walls extending between said side walls;
a pair of door panels, each door panel having a top portion and a main portion extending from said top portion at an obtuse angle, said top portion of each said door panel being hingedly coupled to an associated one of said side walls; and
a door actuator coupled to said top portions of said door panels for selectively pivoting said door panels apart to release said threaded bolts collected in said bolt tray.

16. A bolt thread damage prevention assembly comprising:
a bolt production assembly;
threaded bolts produced by said bolt production assembly;
a bolt tray for receiving said threaded bolts;
a drop pan for holding said bolt tray while said bolt tray receives said threaded bolts;
oil positioned in said drop pan;
a plurality of air jets coupled to said drop pan for creating turbulence in said oil in said drop pan;
wherein said bolt tray is perforated for permitting said oil to enter said bolt tray in a turbulent state;
a distribution conveyor belt positioned to transport said threaded bolts from said bolt production assembly and drop said threaded bolts into said bolt tray while said bolt tray is positioned in said drop pan whereby said threaded bolts are dropped into said oil while said oil is in said turbulent state;
a collection pan for collecting threaded bolts from said bolt tray;
a bolt tray transport assembly for moving said bolt tray from said drop pan to said collection pan;
a second bolt tray operationally coupled to said bolt tray transport assembly to facilitate collection and packaging of said threaded bolts;
a bolt thread testing assembly;
a collection conveyor belt positioned adjacent to said support structure for periodically collecting a sample threaded bolt and transporting said sample threaded bolt to said bolt thread testing assembly;
said bolt tray transport assembly having a bolt collection track portion for moving said bolt tray relative to said distribution conveyor belt to facilitate even distribution of threaded bolts in said bolt tray;
casters positioned on said drop pan such that said drop pan moves with said bolt tray when said bolt tray is moved on said bolt collection track portion;
a drip pan for collecting residual oil dripping from said threaded bolts when said bolt tray is removed from said drop pan;
an oil collection tube extending between said drip pan and said drop pan such that oil collected in said drip pan circulates back into said drop pan;
an oil pump operationally coupled to said oil collection tube for pumping collected oil from said drip pan to said drop pan;
a computer management system operationally coupled to said bolt thread testing assembly and said collection conveyor belt;
an optical inspection mechanism for inspecting each said sample threaded bolt for defective threading;
a plurality of spaced vanes positioned on said distribution conveyor belt for facilitating spacing of said threaded bolts while on said distribution conveyor belt;
wherein said bolt tray transport assembly transports includes an extendable connection to said bolt tray for selectively elevating said bolt tray out of said drop pan;
wherein said bolt tray transport assembly further includes a bolt distribution track portion for moving said bolt tray from said drop pan to above said drip pan to above said collection pan; and
a drip tray extending between said drop pan and said drip pan, said drip tray being sloped to divert oil falling from said bolt tray into said drip pan.

17. The bolt thread damage prevention assembly of claim 16, wherein said bolt tray and said second bolt tray each further comprise:
a pair of side walls;
a pair of end walls extending between said side walls;
a door panel hingedly coupled to one of said side walls to form a bottom of said bolt tray for supporting threaded bolts collected in said bolt tray; and
a door actuator coupled to said door panel for selectively pivoting said door panel to release said threaded bolts collected in said bolt tray.

18. The bolt thread damage prevention assembly of claim 16, wherein said bolt tray and said second bolt tray each further comprise:
a pair of side walls;
a pair of end walls extending between said side walls;
a pair of door panels, each door panel having a top portion and a main portion extending from said top portion at an obtuse angle, said top portion of each said door panel being hingedly coupled to an associated one of said side walls; and
a door actuator coupled to said top portions of said door panels for selectively pivoting said door panels apart to release said threaded bolts collected in said bolt tray.
